(19) United States
(12) Patent Application Publication
(10) Pub. No.: US 2010/0275481 A1
(43) Pub. Date: Nov. 4, 2010

(54) Devices and Methods for Laundering Machine Advertising

(75) Inventor: Justin H. Oriel, Needham, MA (US)

Correspondence Address: GREENBERG TRAURIG, LLP, ONE INTERNATIONAL PLACE, 20th FL, ATTN: PATENT ADMINISTRATOR, BOSTON, MA, 02110, US

(73) Assignee: Coin-Op Media LLC

(21) Appl. No.: 12/771,532

(22) Filed: Apr. 30, 2010

Related U.S. Application Data
(60) Provisional application No. 61/174,238, filed on Apr. 30, 2009.

(51) Int. Cl. G09F 15/00

(52) U.S. Cl. 40/606.03

(57) ABSTRACT

Devices and methods for laundering machine advertising are disclosed herein. A laundering unit includes a custom design advertisement; and a plurality of surfaces, wherein the plurality of surfaces are sufficiently designed to secure and maintain in place the custom design advertisement, wherein the plurality of surfaces are sufficiently designed to allow for the removal of the custom design advertisement without damaging the plurality of surfaces, and wherein the plurality of surfaces are sufficiently designed to allow for re-securing and maintaining the same custom design advertisement or a different custom design advertisement.

### RELATED APPLICATIONS

This application claims the benefit of and priority to U.S. Provisional Patent Application No. 61/174,238, filed on Apr. 30, 2009, the entirety of this application is hereby incorporated herein by reference.

### FIELD

The embodiments disclosed herein relate to devices used as advertising displays, and more particularly to devices and methods for transforming laundering machines into advertising billboards.

### BACKGROUND

Laundering machines, such as washers, dryers, pressing machines, and other laundering units provide surfaces that advertisers can use with unique effectiveness to promote their products or services. As is commonly known, vended washers and dryers and other laundering units can be and commonly are placed in Laundromats, apartment buildings, condominium complexes, hotels, colleges, universities, retreat centers and hospitalities as well as other sites and venues in which people needing these types of services provided by such machinery may be expected to gather. Advertising on a washer or a dryer located at a Laundromat, for example, could reach an estimated 100 million Americans living in rental housing, which form the primary customer base of the self-serve laundry industry. Devices and methods for transforming laundering machines into advertising billboards are needed.

### SUMMARY

Devices and methods for laundering machine advertising are disclosed herein. According to the aspects illustrated herein, there is provided a device for displaying custom design advertisements on laundering units that includes a laundering unit, custom design advertisement displays, and an attachment mechanism. The attachment mechanism couples the custom design advertisement displays to the laundering unit.

According to aspects illustrated herein, there is provided a laundering unit that includes a custom design advertisement; and a plurality of surfaces, wherein the plurality of surfaces are sufficiently designed to secure and maintain in place the custom design advertisement, wherein the plurality of surfaces are sufficiently designed to allow for the removal of the custom design advertisement without damaging the plurality of surfaces, and wherein the plurality of surfaces are sufficiently designed to allow for re-securing and maintaining the same custom design advertisement or a different custom design advertisement.

According to aspects illustrated herein, there is provided an advertising unit that includes a plurality of laundering units disposed side by side and comprising a plurality of substantially contiguous walls; and a single custom design advertisement attached to and covering substantially all of the plurality of walls.

According to aspects illustrated herein, there is provided a method of providing an advertising unit using a laundering device comprising attaching a custom design advertisement to a plurality of outer walls of the laundering device, the custom design advertisement covering substantially all of the plurality of walls.

According to aspects illustrated herein, there is provided a method of providing an advertising unit using a plurality of laundering devices that includes disposing a plurality of units comprising walls side by side, so that the plurality of walls are substantially contiguous; and attaching to the plurality of substantially contiguous walls a single custom design advertisement adapted to cover substantially all of the plurality of walls.

In an embodiment, the laundering unit is selected from one of a top-loading washer, a front-loading washer, a dryer, a pressing machine or combinations thereof. In an embodiment, custom design advertisement displays may include panels or wraps. Wraps can include film sheets, calendar and cast transit vinyl. In an embodiment, an attachment mechanism couples the custom design advertisement displays to the laundering unit.

### BRIEF DESCRIPTION OF THE DRAWINGS

The presently disclosed embodiments will be further explained with reference to the attached drawings, wherein like structures are referred to by like numerals throughout the several views. The drawings shown are not necessarily to scale, with emphasis instead generally being placed upon illustrating the principles of the presently disclosed embodiments.

FIG. 1 shows a perspective view of a laundering unit. The laundering unit illustrated in FIG. 1 is a top-loading washer.

FIG. 2 shows a perspective view of a laundering unit. The laundering unit illustrated in FIG. 2 is a front-loading washer.

FIG. 3 shows a perspective view of a laundering unit. The laundering unit illustrated in FIG. 3 is a dryer.

FIG. 4 shows a perspective view of a laundering unit. The laundering unit includes one washer stacked on top of another washer.

FIG. 5 shows the laundering unit of FIG. 1 and possible areas where advertising can be displayed.

FIG. 6 shows the laundering unit of FIG. 2 and possible areas where advertising can be displayed.

FIG. 7 shows the laundering unit of FIG. 3 and possible areas where advertising can be displayed.

FIG. 8 shows the laundering unit of FIG. 4 and possible areas where advertising can be displayed.

FIG. 9 shows a schematic illustration of a layout of laundering machines at a Laundromat. The Laundromat can include front-loading washers, stacked washers, and dryers.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

Devices and methods for transforming laundering units into advertising billboards are disclosed herein. The devices disclosed herein are used for transforming exterior or interior walls, panels, lids, and other surfaces of laundering units and other temporary, portable, or otherwise moveable laundry machines into custom design advertising displays.

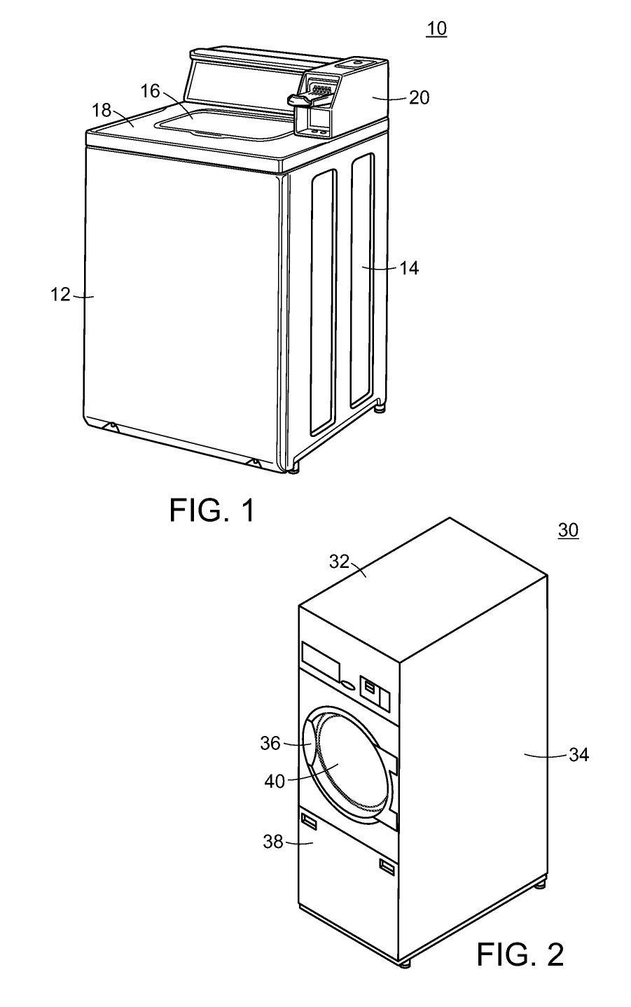

Laundering units, like those shown in FIGS. 1-4, include a plurality of formed metal walls joined by fasteners which may, for example, include rivets, sealants, and adhesives. Raised portions of walls are provided during manufacture, as for example by molding or stamping, in order to provide sufficient structural stiffness in walls and to accommodate mounting of related structures such as a top panel cover, a door handle, a coin acceptor housing, and result in the creation of multi-planar surfaces including outermost surfaces. Vents and other features are often provided for ventilation and other purposes. As used herein, a laundering unit may be a washing machine, a drying unit, a pressing machine or a combination thereof. Laundering units can be found in Laundromats, apartment buildings, college dormitories, commercial buildings, residential homes, or any other type of residential or commercial establishment. Also, laundering units may be coin-operated or card-operated.

FIG. 1 shows a top-loading washer laundering unit 10. Typical top-loading washers 10 can handle between about 12 to about 14 lbs of laundry in any given wash. The top-loading washer 10 includes a front wall 12, a rear wall (not visible), and two side walls 14. The top-loading washer 10 includes a lid 16 at the top of the top-loading washer 10 through which clothes may be loaded. The area 18 around the lid 16 may be a wall. Clothes are loaded in a vertically-mounted perforated basket (not visible) that is contained within a water-retaining tub, with a propeller-like agitator in the center of the bottom of the basket. During a typical wash cycle, the outer tub is filled with water sufficient to suspend the clothing freely in the basket, and the movement of the agitator pulls the clothing downward in the center towards the agitator paddles. The clothing then moves outward and up the sides of the basket to repeat the process. In the embodiment shown in FIG. 1, the top-loading washer 10 includes a coin meter housing 20, although this feature is not necessary.

FIG. 2 shows a front-loading washer laundering unit 30. Typical front-loading washers 30 can handle between about 18 to about 75 lbs of laundry. The front-loading washer 30 includes a top wall 32, a rear wall (not visible), and two side walls 34. The front-loading washer 30 includes a hinged door 36 at the front of the front-loading washer 30. The area 38 around the hinged door 36 may include a wall. In an embodiment, the hinged door 36 may include a window 40. The front-loading washer 30 includes an inner basket (not visible) and an outer tub (not visible) which are mounted horizontally. Agitation is supplied by the back-and-forth rotation of a cylinder and by gravity. The clothes are lifted up by paddles on the inside wall of a drum and then dropped. This motion flexes the weave of the fabric and forces water and detergent solution through the clothes load.

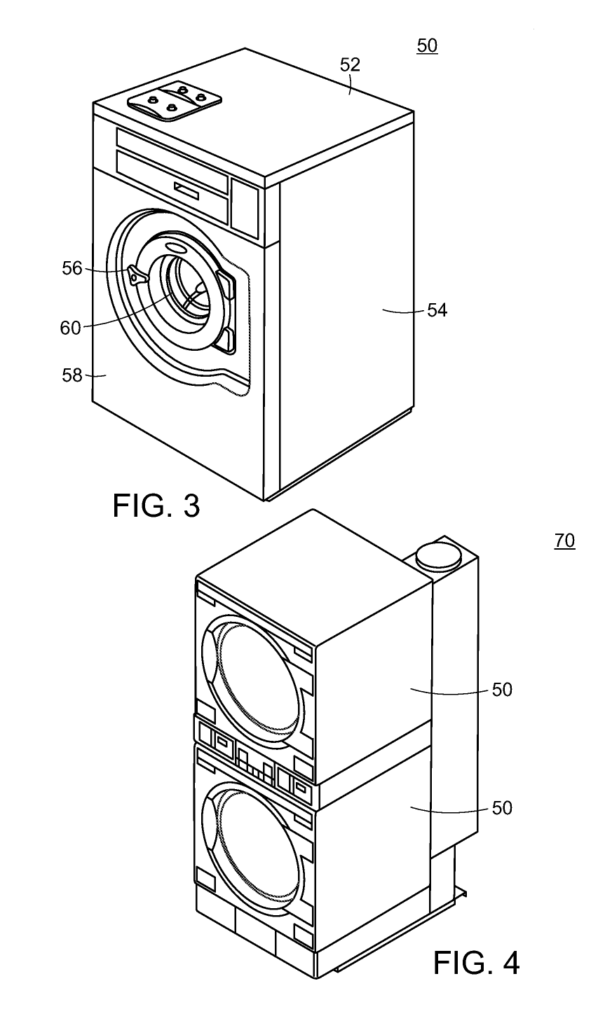

FIG. 3 shows a dryer laundering unit 50. The dryer 50 is used to remove the moisture from a load of clothing, generally shortly after they are cleaned in a washer. The dryer 50 includes a top wall 52, a rear wall (not visible), and two side walls 54. The dryer 50 includes a hinged door 56 at the front of the dryer 50. The area 58 around the hinged door 56 may include a wall. In an embodiment, the hinged door 56 may include a window 60. Dryers may use a front-loading design which mounts the inner basket (not visible) and outer tub (not visible) horizontally.

FIG. 4 shows how laundering units may be stacked on top of one another, for example, in a laundromat. As shown in an embodiment depicted in FIG. 4, one dryer 50 may be placed on top of another dryer 50, calling the combination a “stacked dryer” 70. In an embodiment, one dryer may be placed on top of a washer, calling the combination a “stacker washer/dryer”. The washer in this case may be a front-loading washer.

A laundering unit for use with the present disclosure can be made from sheet steel, usually coated with zinc to improve rust resistance. The steel may be supplied in the form of a coil, which allows the material to be cut to size with minimum waste or automatically fed into the forming process. Some laundry manufacturers manufacture the spin tub of stainless steel. Other models use a steel (called enameling iron) designed for a porcelain coating. For the wash tub, enameling iron with a porcelain coating may be used. Some manufacturers may use plastic instead of enameling iron for the outer wash tub.

Certain parts of laundering units for use with the present disclosure can be made from plastic. Raw plastic may be used for unit components that do not bear weight or require resistance to rust. Examples of parts made from plastic include, but are not limited to, pumps, door handles, tub guards (which prevent your clothes from being thrown out of the spin tub into the wash tub or the cabinet area), and agitators.

In an embodiment of the present disclosure, laundering machines are transformed into advertising billboards through the use of advertisement films. In an embodiment, advertisement films may contain text and/or images adapted for the presentation of desired advertising messages, e.g., “COMPANY NAME OR PRODUCT NAME HERE,” ETC. Advertisements may be selected in order to target desired audiences. Advertisements may be displayed on laundering units in a variety of manners. In an embodiment, a laundering machine is wrapped with an advertisement film having an text, image or both. In an embodiment, the advertisement film is composed of a single panel or sheet. In an embodiment, the advertisement film is composed of more than a single panel or sheet. In an embodiment, the advertisement film is broken up (divided/separated) into more than one panel or sheet. In an embodiment, the advertisement film has any desired thickness, length, and width. In an embodiment, the advertisement film has any desired geographic shape such as, without limitation, square, circular, triangular, rectangular, and pentagonal.

Advertisement films may be designed to prolong the durability and protect the integrity of the laundering unit from scratching, abrasions, detergent spills and any other conditions. In an embodiment, the advertisement film is wear-resistant. In an embodiment, the advertisement film can resist or withstand elements, such as moisture, heat and cooling. In an embodiment, the advertisement film is durable to protect the laundering units from cleaning, such as washing and scrubbing. In an embodiment, the advertisement film is durable to protect the laundering units from very hot or very cold conditions. In an embodiment, the advertisement film is durable to protect the laundering units from mild alkalis, mild acids, salt, water, air, fuel spills or other environment conditions. In an embodiment, advertising films provide a protective shield against tampering and graffiti. In certain instances, the advertisement film can be covered with a lamination designed to prolong the durability and life of the advertisement film.

Advertisement films may be applied or attached to laundering units though various printing and/or transfer processes. In an embodiment, the advertisement film is be pressed onto the laundering units using a press. In an embodiment, the advertisement film is taped, glued or coupled to the laundering units using an adhesive. In an embodiment, the advertisement film wraps, encloses, bounds, or drapes the laundering units. In an embodiment, the advertisement film has a pressure sensitive adhesive and can be cold roll applied to a laundering unit.

In an embodiment, the advertisement film may be releaseably attached to the laundering units in such as a manner that the advertisement film may be removed at a later point. In an embodiment, the advertisement film may engage the laundering units in such as a manner that the advertisement film may be removed and reattached at a later point. In an embodiment, the advertisement film may be permanently attached to the laundering units in such as a manner that the advertisement film may not be removed at a later point. In an embodiment, the advertisement film may be removed by peeling, scraping, through the use of chemical solutions, or other known methods in the art.

To provide an advertisement film with a text, image or both, the text and/or image can be applied to the advertisement film. Once applied, the text and/or image is embedded or engrained into the advertisement film. In an embodiment, the text and/or image can be directly printed onto the advertisement film. To print the desired text and/or image onto the advertisement film, printers, such as ink jet printers, laser printers, or any other printers may be used. In an embodiment, the text and/or image may be transferred onto the advertisement film. To transfer a desired image or symbol onto the advertisement films, a wide variety of suitable inks may be employed in printing and silk screening, including, for example, inks cured by exposure to ultraviolet (UV) radiation. In an embodiment, advertising images are printed on styrene and the advertisement film are thermal/vacuum formed or stamped onto the desired panels of a laundering unit, creating an ad with contours that match those of the exterior panels of the laundering unit. In an embodiment, the ad printing process involves the use of plastic-based UV cured inks.

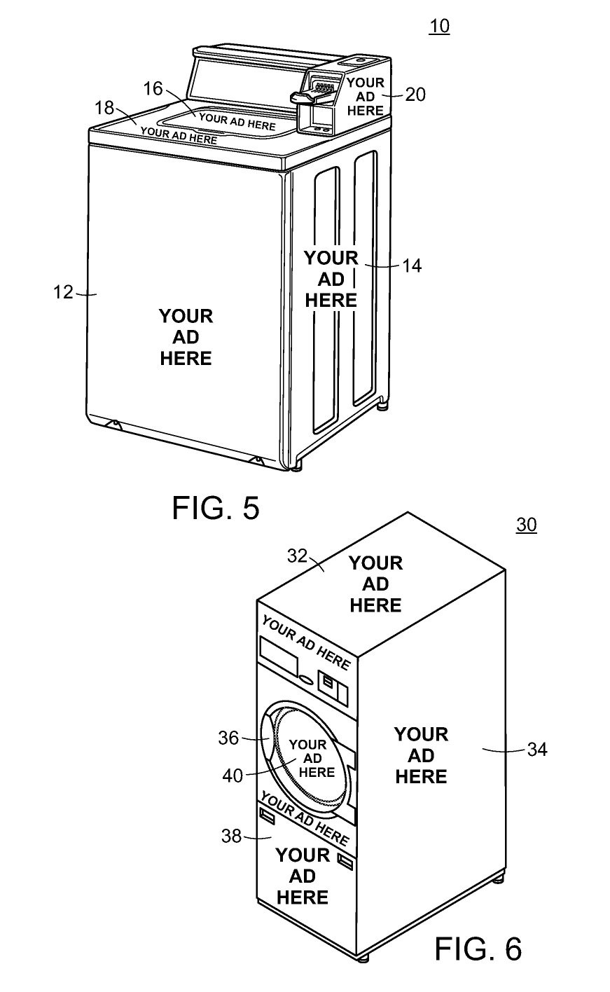

As shown in FIG. 5, the top-loading washer 10 may include areas suitable for displaying advertisement films. In an embodiment, an advertising film may be placed on the front wall 12 of the washer 10, the lid 16 of the washer 10, the area 18 that surrounds the lid 16, and any one of the sides 14 of the washer 10. When washers 10 are lined up in a row, advertisement film may be placed on the sides 14 of the washers 10 that are located at either end. In an embodiment, advertisements may be placed on the coin meter housings 20.

As seen in FIG. 6, the front-loading washer 30 may include areas suitable for displaying advertisements film. In an embodiment, an advertisement film may be placed on the top 32 of the washer 30, the area 38 surrounding the door 36, and any one of the sides 34 of the washer 30. When washers 30 are lined up in a row, advertisement film may be placed on the sides 34 of the washers 30 that are located at either end.

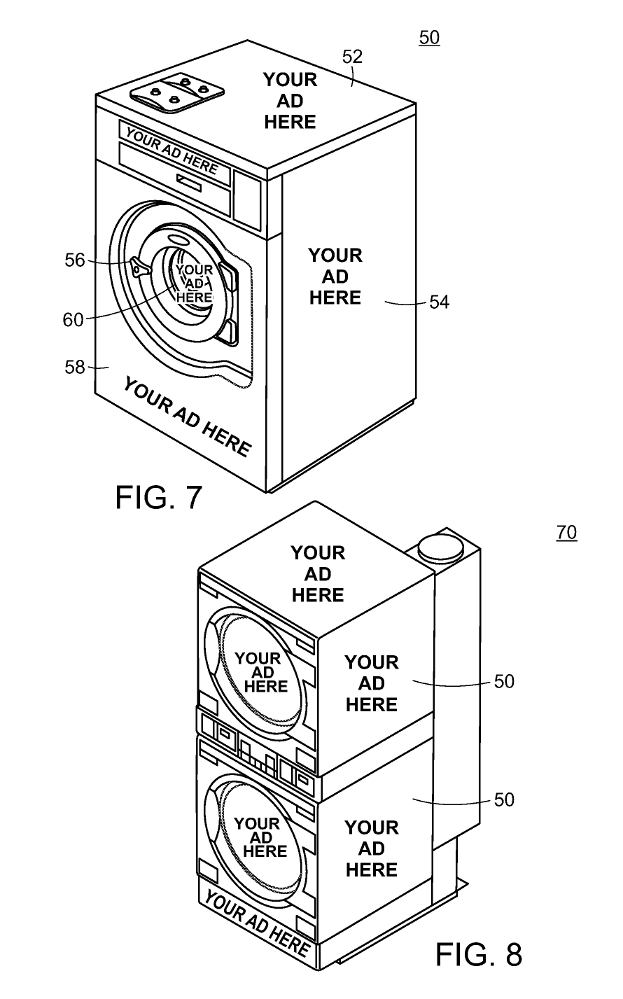

As illustrated in FIG. 7, the dryer 50 may include areas suitable for displaying advertisement film. In an embodiment, an advertisement film may be placed on the top 52 of the dryer 50, the area 58 surrounding the door 56, and any one of the sides 54 of the dryer 50. Due to the fact that most laundromats have similar dryers 50 as illustrated in FIG. 7 lined up in a row, the dryers 50 that will display advertisement film on the sides 54 to the consumers will be the units that are on the end, as these advertisement films will be the only ones exposed to the consumers.

Advertisement film on any of the laundering units illustrated in FIGS. 5-7 can be made out of wood, glass, vinyl, plastic, styrene sheets, acrylic enamel, aluminum, chrome, ABS resins, paint, or any other material. In an embodiment, the advertisement film may include a tensile strength from about 3 pounds/inch to about 7 pounds/inch, although those skilled in the art will appreciate that other ranges may also be acceptable. In an embodiment, the advertisement film has a thickness from about 0.03 mm to about 0.15 mm. In an embodiment, the advertisement film has a thickness from about 0.020 to about 0.030 inches. It should be appreciated, however, that other thickness are also acceptable as the present invention is not limited to be limited in this manner.

Advertisement films may be durable to withstand cleaning of the laundering units, such as washing and scrubbing, and should be capable of remaining affixed in all temperature conditions, such as very hot or very cold conditions. Advertising films should be tamper-proof and graffiti-proof to withstand tampering. In an embodiment, the advertisement film is capable of withstanding or resisting mild alkalis, mild acids, salt, water, air, fuel spills or other environment conditions. In an embodiment, the advertisement film includes pressure activation, slideability, repositionability and air release channels to reduce the amount of air or bubbles remaining after applying the advertisement film. In an embodiment, the laminate has a pressure sensitive adhesive and can be cold roll applied to an advertisement film.

Factors that may be considered in the selection of materials to be used in the fabrication of advertisement film include, for example, characteristics of the unit to which the advertisement films are to be attached, the nature of the adhesives to be used in attaching the advertisement films to the unit, and weather and other conditions, including cleaning, to which the unit and advertisement films will be exposed or subjected. In an embodiment, styrene sheets from about 0.020 inches to about 0.030 inches in thickness are considered to hold up well to extreme temperatures and to highly vigorous cleaning processes, such as using strong cleaning solvents or detergents.

In an embodiment, advertisement films may be substantially flat, and may be adapted for attachment to any feature of the laundering unit. In an embodiment, advertisement films conform to the contours of the laundering unit to provide a substantially flat surface. Advertisement film may be provided in pre-cut or otherwise pre-sized form or they may be trimmed to fit using scissors, blades, or other sharp objects. Walls and other surfaces of laundering units having doors and other opening and closing features can be used effectively by adhering suitably-trimmed advertisements to the outer surfaces of the door and any surrounding panels, so that the door or other opening can be opened and closed without hindering use of the unit. In an embodiment, advertisement film may be formed, using for example, moldings. Molds are made of the exterior surfaces of panels of the structure.

Advertisement film may be provided with single advertising images that extend over single or continuously over multiple panels, or groups of related or unrelated images. For example, each wall of a structure, or various portions thereof, may be devoted to advertising related to different products or services, or one or more of panels may be devoted to the presentation of a single, continuous, “wrapped-around” image. In an embodiment, advertising may be provided on a wall and/or one or more vents, door handles, or other features to be left uncovered by panel(s), so as to allow the vents or other features to function more effectively. In an embodiment, advertising images and/or advertisement films may be provided on one or more interior or exterior surfaces of a unit.

Adhesives may be applied directly to the walls of the laundering units or to the advertisement film to connect the advertisement film to the laundering unit. In an embodiment, one side of the advertisement film includes an adhesive. In an embodiment, tape, glue, or other adhesives may be applied by spraying, brushing, or in other ways to one or more of the walls on the laundering unit. One or more of advertisement films may then be placed in a desired position and adhered to the tape or other adhesive. In an embodiment, 3M 4408 double-sided vinyl foam tape provides satisfactory performance in applications where warm temperatures are anticipated. In an embodiment, weather resistant, double-sided mounting tape, such as Scotch 3M 4011, provides useful lives of approximately two years under typical service conditions in which the unit and advertisement films are exposed to various temperatures and repeated washing processes with different cleaning solvents. Adhesives, including for example double-sided tapes, glues, as disclosed herein, offer several advantages over permanent fasteners such as rivets in that advertisement films may be changed easily, without damage to the supporting walls of unit. In this way it is possible to renew advertising campaigns, as for example when advertisement films become damaged, worn or weathered, and to change advertisements altogether, as for example when a first advertising campaign ends and is replaced by a second. In an embodiment, the adhesive may have a thickness ranging from about 0.01 mm to about 0.08 mm.

In some embodiments, a laminate may be placed over the advertisement film. The laminate may prolong the durability of the advertisement film. The laminate may be designed to provide ultraviolet and physical protection. In an embodiment, the laminate has a thickness from about 0.01 mm to about 0.17 mm, although those skilled in the art will appreciate that other ranges may also be acceptable. In an embodiment, the laminate has a tensile strength from about 2 pounds/inch to about 8 pounds/inch, although those skilled in the art will appreciate that other ranges may also be possible. In an embodiment, the laminate has a dimensional stability from about 0.001 inches to about 0.002 inches. In an embodiment, the laminate is designed to resist mild alkalis, mild acids, salt, water, petroleum vapors, and other environmental conditions. In an embodiment, the laminate has a pressure sensitive adhesive and can be cold roll applied to an advertisement film. Those skilled in the art will appreciate that other methods of applying the laminate to the advertisement film are also possible and are within the scope and spirit of the present disclosure.

In an embodiment of a device of the present disclosure, advertisements may be displayed through the use of wraps. A wrap may have one or more advertising images printed or otherwise provided on one side and may be affixed to one or more surfaces of the laundering unit using an adhesive. In an embodiment of the present disclosure, a wrap may include film sheets. In an embodiment, 3M products may be used for the wraps. In an embodiment, 3M 181 film and 8519 3M laminate may be used to wrap the units. Film sheets of this kind are weather resistant and allow flexibility when creating a wrap using these materials. In an embodiment, film sheets include air to prevent bubbles or microscopic glass beads from forming and preventing the adhesive from taking hold until squeegeed down. Film sheets may allow for easier removal such that the film may be lifted and reapplied as needed during the wrapping process, without compromising the longevity of the wrap.

In an embodiment, wraps can cover side and rear walls of a laundering unit. Wraps placed on the window of the door may be perforated to allow viewing of garments during washing or drying. A wrap may be divided into a number of smaller pieces to appropriately cover any surface on the washer or dryer, such as the door handle, start buttons, coin meter housings, and other surfaces that may display advertising.

In an embodiment, a wrap may include calendar and cast transit vinyl. Advertisements may be printed on vinyl material and adhered to the walls of the laundering units. Such wraps may be applied using cold application processes or adhesives already applied to the back side of the vinyl. Two-sided tapes, such as those described above, can be used to supplement the adhesives provided on the vinyl material. In an embodiment, a heat gun or other source of heat may be used to stretch the vinyl and adhere the vinyl to all contours of the panels of the unit.

As described in connection with other embodiments of the device of the present disclosure, film sheets, calendar and cast transit wraps according to the present disclosure may be provided with one or more continuous, related, or unrelated advertising images. It may be advantageous for various features of the unit, such as the outer panel and/or more vents, door handles, or other features to be left uncovered by panel(s), so as to allow vents or other features to function more effectively.

An advantage offered by the use of wraps, including for example film sheets, calendar and cast transit vinyl wraps, as disclosed herein, as opposed to panels affixed using permanent fasteners such as rivets, is that advertising displays may be changed easily, without damage to the walls of unit. In this way it is possible to renew advertising campaigns when, for example, image-bearing wraps become damaged, worn, or weathered, and to change advertisements altogether, as for example when a first advertising campaign ends and is replaced by a second. To effect such changes, the old wrap may, for example, be removed and replaced or a new wrap may be installed atop the previous wrap.

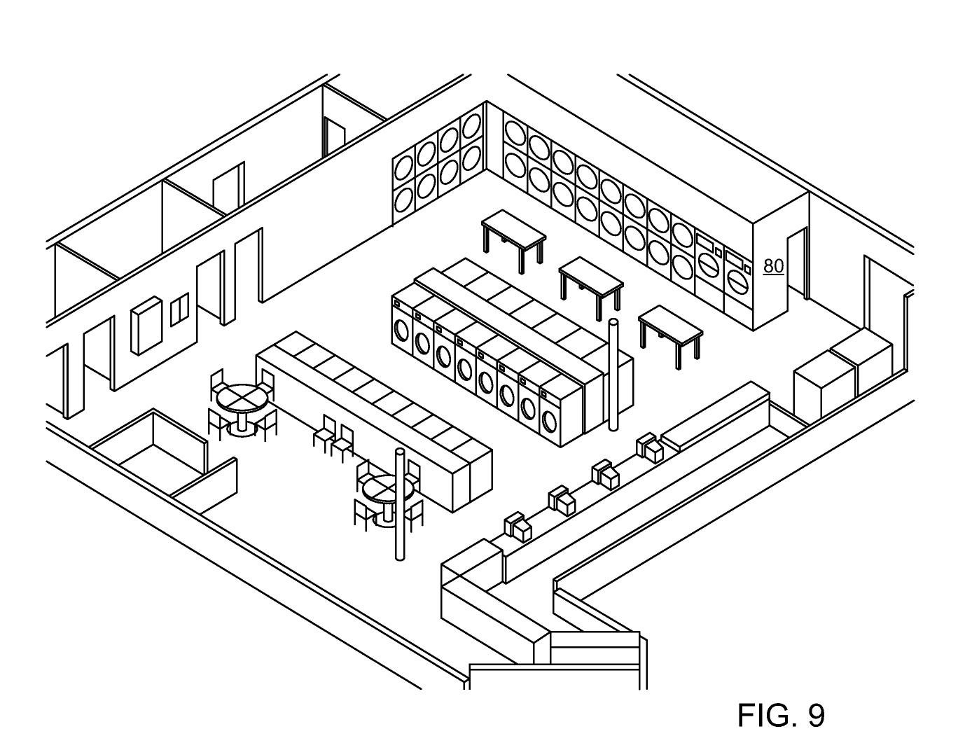

In both advertisement film and wrap embodiments of the device of the present disclosure, the display of multiple-surface advertisements may be enhanced by placing multiple moveable advertising units, such as washer or dryer positioned beside each other such that the back, front, and side walls form substantially contiguous surfaces suitable for the attachment and support of advertising images larger than could be supported by a single unit or on a single wall unit. For example, as shown in FIG. 9, a row of laundering units 80 may be placed side by side such that their front walls form a substantially continuous surface suitable for the attachment of a single advertisement. In FIG. 9, a row of several units 80 have been placed side by side such that their front (and rear) faces form a substantially continuous wall to which a single advertisement can be attached. Advertisements may be formed from one or more panels or wraps covering a plurality of faces, or from a plurality of panels or wraps, each wrap or panel covering a single face.

In other aspects, the device of the present disclosure provides methods of attaching such advertising material to the laundering devices, and methods of producing or otherwise providing such advertising materials. A method for wrapping a laundering unit includes creating a custom design advertisement for an advertiser that will be displayed on the laundering unit; printing the custom design advertisement; preparing the laundering unit for accepting the custom design advertisement; applying the custom design advertisement to the laundering unit; adhering the custom design advertisement to the laundering unit; and bonding of the custom design advertisement to the laundering unit. The method incorporates special software, quality printing inks, superior film materials and laminates that can handle the rigorous environments of a Laundromat. In an embodiment, the custom design advertisement is printed onto quality 3M removable film. In an embodiment, the custom design advertisement is printed onto electrostatic perforated window film. In an embodiment, the custom design advertisement is printed onto reflective film. The custom design advertisement can be covered with laminate to protect the advertisement. The characteristics of the film and the contours of the laundering unit will determine how well the custom design advertisement will perform and will determine the thickness of films used. Various forms of dirt and grease can be found on laundering units, therefore, industry standard cleaners are used to remove these contaminants prior to advertisement application (the preparing step of the method). In an embodiment, primers are added where needed to aide in film adhesion. Stretching and the use of an industry standard squeegee to smooth over the contours of the laundering unit may be required to adhere the film to the laundering unit's surface(s). In areas with tight contours, a heat gun in combination with a squeegee can be used to properly adhere the film to the laundering unit. After the custom design advertisement has been applied and the film smoothed out over the laundering units contour and concave surfaces, a heat gun can be used at approximately 200° F. to aide in the bonding of the film in complex areas. This insures a proper bond and long life for the wrap on the laundering unit.

In an embodiment, a laundering unit includes a custom design advertisement; and a plurality of surfaces, wherein the plurality of surfaces are sufficiently designed to secure and maintain in place the custom design advertisement, wherein the plurality of surfaces are sufficiently designed to allow for the removal of the custom design advertisement without damaging the plurality of surfaces, and wherein the plurality of surfaces are sufficiently designed to allow for re-securing and maintaining the same custom design advertisement or a different custom design advertisement.

In an embodiment, an advertising unit includes a plurality of laundering units disposed side by side and comprising a plurality of substantially contiguous walls; and a single custom design advertisement attached to and covering substantially all of the plurality of walls.

In an embodiment, a method of providing an advertising unit using a plurality of laundering devices includes disposing a plurality of units comprising walls side by side, so that the plurality of walls are substantially contiguous; and attaching to the plurality of substantially contiguous walls a single custom design advertisement adapted to cover substantially all of the plurality of walls.

In an embodiment, a method of providing an advertising unit using a laundering device comprising attaching a custom design advertisement to a plurality of outer walls of the laundering device, the custom design advertisement covering substantially all of the plurality of walls.

All patents, patent applications, and published references cited herein are hereby incorporated by reference in their entirety. It will be appreciated that several of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A laundering unit comprising:
a custom design advertisement; and
a plurality of surfaces,
wherein the plurality of surfaces are sufficiently designed to secure and maintain in place the custom design advertisement,
wherein the plurality of surfaces are sufficiently designed to allow for the removal of the custom design advertisement without damaging the plurality of surfaces, and
wherein the plurality of surfaces are sufficiently designed to allow for re-securing and maintaining the same custom design advertisement or a different custom design advertisement.

2. The laundering unit of claim 1 wherein the laundering unit is one of a washing machine, a drying unit, a pressing machine or combinations thereof.

3. The laundering unit of claim 1 wherein the surfaces are molded and include multi-planar surfaces.

4. The laundering unit of claim 3 wherein the custom design advertisement is attached to an outermost planar surface.

5. The laundering unit of claim 3 wherein the custom design advertisement is formed to conform to the multi-planar surfaces.

6. The laundering unit of claim 1 wherein the custom design advertisement is disposed on a flexible film and the film is adhered to the surfaces.

7. The laundering unit of claim 1 wherein the custom design advertisement is disposed on one or more rigid sheets and the sheets are adhered to the surfaces.

8. The laundering unit of claim 1 wherein at least one of the surfaces includes a door, and the custom design advertisement is adapted to cover the door and a remainder of the surface.

9. An advertising unit comprising:
a plurality of laundering units disposed side by side and comprising a plurality of substantially contiguous walls; and
a single custom design advertisement attached to and covering substantially all of the plurality of walls.

10. The unit of claim 9 wherein the single custom design advertisement is provided on a plurality of panels attached separately to each of the substantially contiguous walls.

11. The unit of claim 9 wherein the single custom design advertisement is provided on a single panel attached to each of the substantially contiguous walls.

12. A method of providing an advertising unit using a plurality of laundering devices comprising:
disposing a plurality of units comprising walls side by side, so that the plurality of walls are substantially contiguous; and
attaching to the plurality of substantially contiguous walls a single custom design advertisement adapted to cover substantially all of the plurality of walls.

13. The method of claim 12 wherein the single custom design advertisement is provided on a plurality of panels, wherein each of the plurality of panels are attached separately to each of the substantially contiguous walls.

14. The method of claim 12 wherein the single custom design advertisement is provided on a single panel, wherein the single panel is attached to each of the substantially contiguous walls.

15. The method of claim 12 wherein the walls are molded and include multi-planar surfaces, and the single custom design advertisement is attached to an outermost planar surface only.

16. The method of claim 12 wherein the walls are molded and include multi-planar surfaces, and the single custom design advertisement is conformed to a shape of the multi-planar surfaces.

17. The method of claim 12 wherein the custom design advertisement is adapted to allow a door included in at least one wall of the laundering device to open and close after the single custom design advertisement is attached.
